(19) United States
(12) Patent Application Publication
(10) Pub. No.: US 2025/0289715 A1
(43) Pub. Date: Sep. 18, 2025

(54) OXIDIZING SOLUTIONS AND METHODS FOR INCREASING HEAT PRODUCTION IN HYDROGEN-PRODUCING SUBSTANCES REACTING WITH WATER

(71) Applicant: U.S. Army DEVCOM, Army Research Laboratory, Adelphi, MD (US)

(72) Inventors: Anthony J. Roberts, Chesapeake City, MD (US); Anit K. Giri, Abingdon, MD (US); Billy C. Hornbuckle, Bel Air, MD (US); Thomas L. Luckenbaugh, Spring Grove, PA (US); Kristopher A. Darling, Havre de Grace, MD (US)

(21) Appl. No.: 18/607,749

(22) Filed: Mar. 18, 2024

(51) Int. Cl. C01B 3/08; C22C 18/00; C22C 21/00

(52) U.S. Cl. CPC C01B 3/08; C22C 18/00; C22C 21/00; C22C 21/003

(57) ABSTRACT

Methods, solutions and material systems for increasing the heat yield for a substance which reacts with water to produce hydrogen gas and heat are disclosed herein. The methods include providing a substance which reacts with water to produce hydrogen gas and heat, providing an aqueous solution comprising an oxidizer and an optional salt, and reacting the substance and the composition to generate hydrogen and heat.

### GOVERNMENT INTEREST

The embodiments herein may be manufactured, used, and/or licensed by or for the United States Government without the payment of royalties thereon.

### BACKGROUND

### Technical Field

The embodiments herein generally relate to hydrogen and/or heat production, and more particularly to oxidizing solutions and methods for increasing heat production in hydrogen-producing substances reacting with water.

### Description of the Related Art

Many substances, such as aluminum, react with water to produce hydrogen via hydrolysis reaction. However, immediate oxidation occurs at room temperature when the particles come in contact with air or water to form a continuous oxide layer on the free surface. The oxide layer inhibits reaction preventing further hydrolysis. The ability to disrupt this oxidation/passivation mechanism is key to allow efficient production of hydrogen via reaction with water.

The U.S. Army Research Laboratory developed nanogalvanic aluminum-based alloy compositions that generate hydrogen very rapidly by reaction with water at room temperature by forming galvanic cells which are disclosed and claimed in U.S. Pat. No. 11,198,923 titled “Aluminum based nanogalvanic compositions useful for generating hydrogen gas and low temperature processing thereof,” herein incorporated by reference in its entirety. The galvanic effect continuously allows the exposure of new unoxidized metallic surface and thus allow further hydrolysis at room temperature The alloys may be composed of primarily aluminum and other metals e.g. tin, bismuth, indium, gallium, etc. and/or graphite. In presently known Al water reactions, only 15.4 MJ/kg of energy can be harvested as heat, with the remaining 15.9 MJ/kg of energy in the form of hydrogen gas (H₂).

Improvements in heat generation for hydrogen-producing substances reacting with water, like the disclosed '923 patented material and many others, are desired.

### SUMMARY

The present invention involves the hydrogen and/or heat production. To these ends, methods, solutions and material systems for increasing the heat yield for a substance which reacts with water to produce hydrogen gas and heat are disclosed herein.

According to embodiments, the methods include providing a substance which reacts with water to produce hydrogen gas and heat, providing an aqueous solution comprising an oxidizer and an optional salt, and reacting the substance and the composition to generate hydrogen and heat.

The oxidizer may include hydrogen peroxide (H₂O₂), potassium nitrate (KNO₃), sodium nitrate (NaNO₃), potassium permanganate (KMNO₄), chromium trioxide (CrO₃) or potassium dichromate (K₂Cr₂O₇) as a few non-limiting examples. In embodiments, the oxidizer may be about 1-50% (by wt.) of the aqueous solution, for instance. The optional salt is present in some preferred embodiments. The salt may comprise a chloride of a group 1 element such as sodium chloride (NaCl), potassium chloride (KCl), rubidium chloride (RbCl) or cesium chloride (CsCl) as a few non-limiting examples. For instance, the salt may be about 0.5 milli mole to 10 moles of the aqueous solution as non-limiting values. The substance which reacts with water to produce hydrogen gas and heat can include aluminum (Al) and Al-alloys, magnesium (Mg) and Mg-alloys, zinc (Zn) and Zn-alloys, silicon (Si) and Si-based compositions, as non-limiting examples. The aluminum alloy may comprise nanogalvanic aluminum alloy formed of Al and 3 at. % Sn, AA5083, AA5056, AA6061or AlGaIn alloy, for example. The method may further comprise milling the substance which reacts with water to produce hydrogen gas and heat to reduce particle size.

Preferably, improvements for a reaction of at least 10%, and more preferably 25% in some instances, are desired. In one non-limiting attempt to quantify, the added improvement to the reaction using an oxidizer and/or a salt (optional), should be significant, that is, it should be at least 10.5 MJ per kg of Al for Al-containing substances; it should be at least 0.6 MJ per kg for Mg for Mg-containing substances.

These and other embodiments of the invention are described in more detail, below.

### BRIEF DESCRIPTION OF THE DRAWINGS

The embodiments herein will be better understood from the following detailed description with reference to the drawings, in which:

FIGS. 1A and 1B show an overview of aspects of the invention, where FIG. 1A shows a simplified chemical reaction according to embodiments of the present invention, and FIG. 1B shows a method for increasing the heat yield for a substance which reacts with water to produce hydrogen gas and heat according to embodiments; and

FIGS. 2-9 are various plots showing heat generation as a result of different reactions according to our experiments involving aluminum, magnesium, and AlGaIn for the hydrogen-producing substance as a result of certain reactions according to embodiments of the present invention.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art of practice the embodiments herein. Accordingly, the examples should not be construed as limiting the scope of the embodiments herein.

### DETAILED DESCRIPTION

The present invention provides novel solutions which improve heat-generation and-yield for reactions involving hydrogen-generating substance which react with water to produce hydrogen (in gaseous form) and heat.

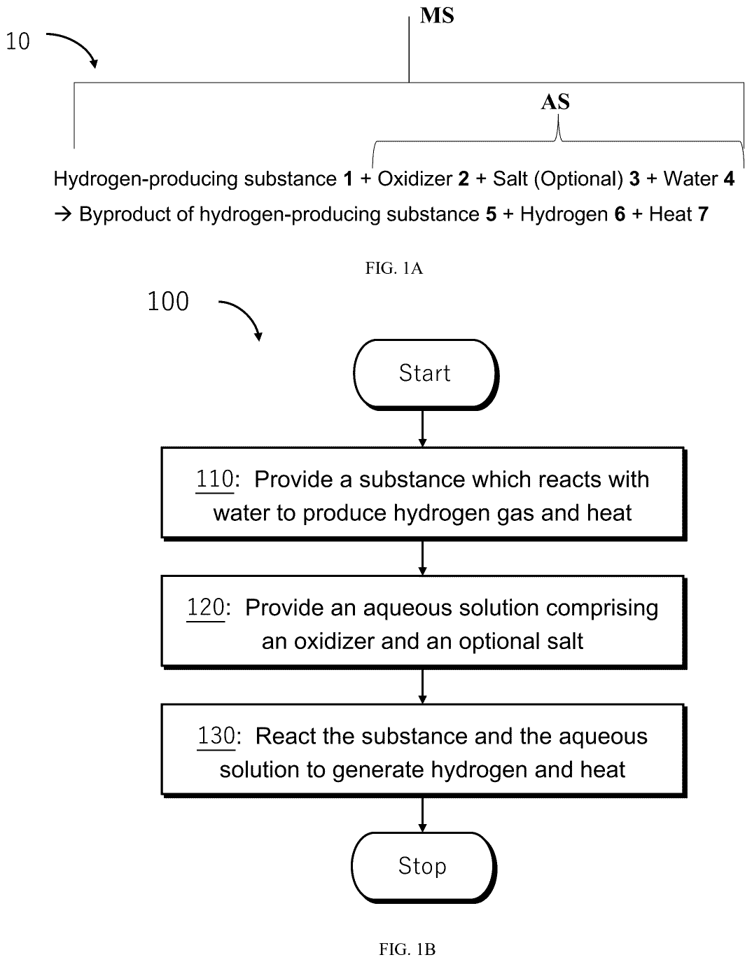

FIG. 1A shows a simplified chemical reaction 10 according to embodiments of the present invention. This an exothermic reaction, i.e., it discharges heat to the environment. Put another way, it gets hot. It comprises, as inputs (i.e., reagents), a hydrogen-producing substance 1, an oxidizer 2, a salt (optional) 3 and water or water-containing liquid 4. These inputs react to form outputs including byproduct(s) of the hydrogen producing material 5, hydrogen gas 6 and heat 7.

Byproduct(s) of the hydrogen producing material 5 may include various oxides, hydrides or combination thereof, of the substance 1 produced via the hydrolysis reaction (e.g., for Al, the byproduct 5 could be aluminum oxide (Al₂O₃); for Mg, magnesium oxide (MgO). Of primary concern is the output of hydrogen gas 6 and heat 7. The oxidizer 2, salt (optional) 3 and water or water-containing liquid 4 may be provided as an aqueous solution AS in some embodiments for reacting with the hydrogen-producing substance 1. The reactions occur more rapidly in the presence of an oxidizer 2 and optional salt 3. In a sense, the oxidizer 2 and the optional salt 3 function as a facilitator and catalyst, respectively, for the reaction of the hydrogen-producing substance 1 and water to produce the outputs.

In some embodiments, the aqueous solution AS may enable for hydrogen and heat generation at room (or low) temperatures without requiring additional catalysts or means such as elevated temperature, alkaline water, or externally coupled power.

And a material system MS may be provided comprising the hydrogen-producing substance 1 and aqueous solution AS for producing hydrogen gas 6 and/or heat 7. The hydrogen 6 produced could be used commercially for power generation through turbine. The heat 7 produced may be used in various applications, such to boil water to produce steam (or superheated-steam) for steam-applications. This allows for efficient way to convent the energy into electrical power via using steam turbines. The heat 7 can also be used for drying, antimicrobial, steam-heating, fuel production, and many other chemical reactions relying on heat (thermal energy) as an input.

The material system MS could be designed to keep the hydrogen-producing substance 1 and aqueous solution AS initially separate in discreet compartments, and provide a reaction-trigger means, such that when their reaction is desired, the aqueous solution AS can cross from its compartment into the other so as contact the hydrogen-producing substance 1. Such reaction-trigger means might include a tear, break-able portion, puncture, perforation, etc.

Alternatively, the hydrogen-producing substance 1 could be configured as powders or pellets which “drop-in” in the aqueous solution AS to generate power or heat in the field remotely i.e., in-field. Because of their high surface area per volume, powdered or atomized hydrogen producing metals and alloys are expected to generate hydrogen more rapidly than their bulk counterparts. This has been demonstrated for silicon as reported by Folarin Erogbogbo, et al., “On-Demand Hydrogen Generation using Nanosilicon: Splitting Water without Light, Heat, or Electricity,” Nano Lett. 2013, 13, 451-456. Replacements for the hydrogen-producing substance 1 and/or the aqueous solution AS can effectively allow for “on-going” reactions. The hydrogen-producing substance 1 can include any material or substance which readily reacts with water (H₂O) to produce hydrogen (H₂) and heat. They may comprise many metals such as aluminum (Al) and Al-alloys, magnesium (Mg) and Mg-alloys, zinc (Zn) and Zn-alloys, silicon (Si) and Si-based compositions. The aluminum alloy may comprise nanogalvanic aluminum, aluminum alloys of 1000, 2000, 3000, 5000, 6000 and 7000 series (such as AA5083, AA5056, AA6061 as a few non-limiting examples) or Al alloys containing Ga and/or In alloy, as a few non-limiting examples.

The Mg alloys may be selected from various Mg alloys commonly designated in the United States by two capital letters followed by two or three numbers. The letters stand for the two major allying elements in the alloy, with the first letter indicating the one in the highest concentration the second letter indicating the one in the second highest concentration. The first number following the letters stands for the weight percent of the first letter element (if there are only two numbers) and the second number stands for the weight percent of the second letter element, where A=aluminum, Z=zinc, M=manganese, E=rare earths, H=thorium, K=zirconium, Q=silver, T=tin, W=yttrium and S=silicon. (See William F. Smith, Structure and Properties of Engineering Alloys, McGraw-Hill 2^{nd} edition NY, 1993, pp. 540-541). Such alloys, for example, may be selected from the group consisting of: AMxx, ASxx, AZxx, ZKxx, EZxx, ZExx, QExx, EQxx, and Wexx, in some non-limiting embodiments. In other nomenclatures, the Mg alloys could be comprised of Mg-2.7 wt. % Ni, Mg-2.7 wt. % Ni-1wt.%Sn, Mg-10 wt. % In, Mg-10 wt. % Sn, Mg-10 wt. % Bi, etc.

Zn alloys may be comprised of Zn—Mg They may be castable and wrought alloys: like Zn—Al alloys, and/or incorporate lead, cadmium, copper and other low fraction elements, for example. The Si alloys may comprise Si—Fe alloys (Ferrosilicon) as some examples. The nanogalvanic aluminum material may be prepared according to the aforementioned disclosure and claims of the aforementioned U.S. Pat. No. 11,198,923. It may be formed of Al and 3 at. % tin (Sn), as a non-limiting example, for instance. It may also be formed of Al and 3 at. % bismuth (Bi), as a non-limiting example, for instance, or a mixture of Al, Sn and Bi. Such material could be sourced from minimal processing of scrap and waste alloys.

The oxidizer 2 may be any chemical “oxidizer” or “oxidizing agent” compatible with via hydrolysis reaction(s). An oxidizer, also known as an oxidizing agent, is defined as a substance that facilitates the process of oxidation in a chemical redox reaction by accepting electrons from another substance, which results in the reduction of the oxidizer. In other words, an oxidizer is a compound that causes the oxidation of another compound by taking away its electrons. Because it accepts electrons it is also called an electron acceptor. A catalyst is a substance that speeds up a chemical reaction but is not consumed by the reaction; hence a catalyst can be recovered chemically unchanged at the end of the reaction it has been used to speed up or catalyze. In this case, the oxidizer 2 operates on the hydrogen-producing substance 1 while the catalyst 3 speeds or catalyzes the overall reaction i.e. the oxidation of hydrogen-producing substance 1 and the breakdown of the oxidizer 2. For instance, the oxidizer 2 in various embodiments may include hydrogen peroxide (H₂O₂), potassium nitrate (KNO₃), sodium nitrate (NaNO₃), potassium permanganate (KMNO₄), chromium trioxide (CrO₃), potassium dichromate (K₂Cr₂O₇) or mixtures thereof, as a few non-limiting examples. The oxidizer 2 may comprise up to about 1-50% (by wt.) of the aqueous solution AS in some non-limiting embodiments.

Commercially available solutions exist containing between about 1-98% (by wt.) of hydrogen peroxide. They can be easily diluted with water as may be needed for embodiments.

The salt 3 may be optional in some instances but has been found to provide improved heat generation results and thus preferred for many embodiments. The term “salt,” as used herein, refers to a chemical compound consisting of an ionic assembly of positively charged cations and negatively charged anions, which results in a compound with no net electric charge. A common example is table salt, primarily comprising sodium chloride (NaCl) with positively-charged sodium ions and negatively-charged chloride ions. For instance, various salts of chlorides of Group 1A elements may be used in various embodiments, in addition to sodium chloride (NaCl), including potassium chloride (KCl), rubidium chloride (RbCl) or cesium chloride (CsCl). The salt may comprise as little as 0.5 milli mole to upwards of 10 moles of the aqueous solution in some non-limiting examples.

The water or water containing liquid 4 should be of sufficient quantity to fully react with the hydrogen-producing substance 1. Excess water should be provided for this purpose. The greater purity of the water or water containing liquid 4 the better. The water or water-containing liquid 4 may include but is not limited to gray water, urine, pond water and so forth.

These inputs react to form byproduct of the hydrogen producing material 5, hydrogen 6 (i.e., in the form of gaseous H₂) and heat 7. Of primary concern is the output of hydrogen 6 and/or heat 7. We consider three examples, below, for aluminum, magnesium, and AlGaIn for the hydrogen-producing substance 1.

In the plots presented in the figures herein, the data for a hydrogen-producing substance's 1 (e.g. Al, Mg or AlGanIn) reaction with just water 4 (H₂O) is considered a baseline. For higher (percentage of) heat generated for a reaction between the hydrogen-producing substance 1 and water 4 and further including an oxidizer 2 and/or a salt (optional) 3, this is an improvement in heat generation over the baseline. The plots demonstrate striking improvements for many such reactions according to various embodiments of the present invention. Preferably, we strive for improvements for a reaction of at least 10%, and more preferably 25% in some instances. In one non-limiting attempt to quantify, the added improvement to the reaction using an oxidizer 2 and/or a salt (optional) 3, should be significant, that is, it should be at least 10.5 MJ per kg of Al for Al-containing substances; it should be at least 0.6 MJ per kg for Mg for Mg-containing substances. As our data further demonstrates, in some instances, the reactions provide even greater improvements. Ultimately, the maximum heat generated could approach, but not exceed, theoretical reaction values. For Al-containing substances, that could be up to about 31.3 MJ per kg of Al; for Mg-containing materials, that could be up to about 6.3 MJ per kg of Mg. (Note: for AlGaIn, the heat is predominantly generated by the reaction of Al with water, so we assume a similar heat generation value up to about 31.3 MJ, per kg of Al).

FIG. 1B shows a method 100 for increasing the heat yield for a substance which reacts with water to produce hydrogen gas and heat according to embodiments.

In step 110, provide a substance 1 which reacts with water to produce hydrogen gas and heat. In some instances, this step may include sourcing the hydrogen-producing substances 1 with small initial particle size or, further reducing the size of the substance's particles, such as through high energy-milling as discussed in the aforementioned '923 patent. High energy ball milling may commence at room temperate or at cryogenic temperature starting with powders of the constituents.

In step 120, provide an aqueous solution comprising an oxidizer and an optional salt. An aqueous solution AS can be prepared comprising, the oxidizer 2, salt (optional) 3 and water or water-containing liquid 4 as described herein and according to the many examples provided too.

Next, in step 130, react the substance and the composition to generate hydrogen and heat. This can be a near instantaneous reaction occurring in 10 s to 100 s of seconds. The reaction can occur at standard room temperature (˜25° C.) and pressure (˜1 atm). Of course, elevated temperatures and lower pressures may generally accelerate the reaction.

This innovation has large potential for alternative and unique designs of energy conversion specifically through steam turbines which are 90% efficient compared utilizing the energy available from hydrolysis and conversion via conventional proton-exchange membrane fuel cells (PEMFC) which are only ˜25% efficient (relative to the total energy available from Al), or combustion reactions.

U.S. Army and DoD and facilities need help to become more energy efficient and resilient. Picatinny Arsenal is installing 2-megawatt hydrogen co-generation facility to enhance energy efficiency that will bring energy savings and make installations more energy independent by reducing the dependency on outside sources. The co-generation design of the facility could use this invention to improve energy efficiency and to generate steam on site. DoD facilities like Picatinny arsenal have mission processes which need steam-energy year-round. This invention also supports the Army's directives for energy security. DoD's installations energy resiliency is improved by having the capability to generate electricity and steam for critical operations on site in the event of a loss of grid electricity.

### Experiments

We performed many experiments to quantify the amount of heat generated versus time.

For every experiment, a specific quantity of a hydrogen-producing metallic substance 1 was introduced into a 100 ml aqueous solution containing varying concentrations of oxidizers 2 with and without salt 3 and the balance of water 4, with subsequent measurement of the solution's reaction temperature. A control experiment was conducted using a solution consisting solely of water.

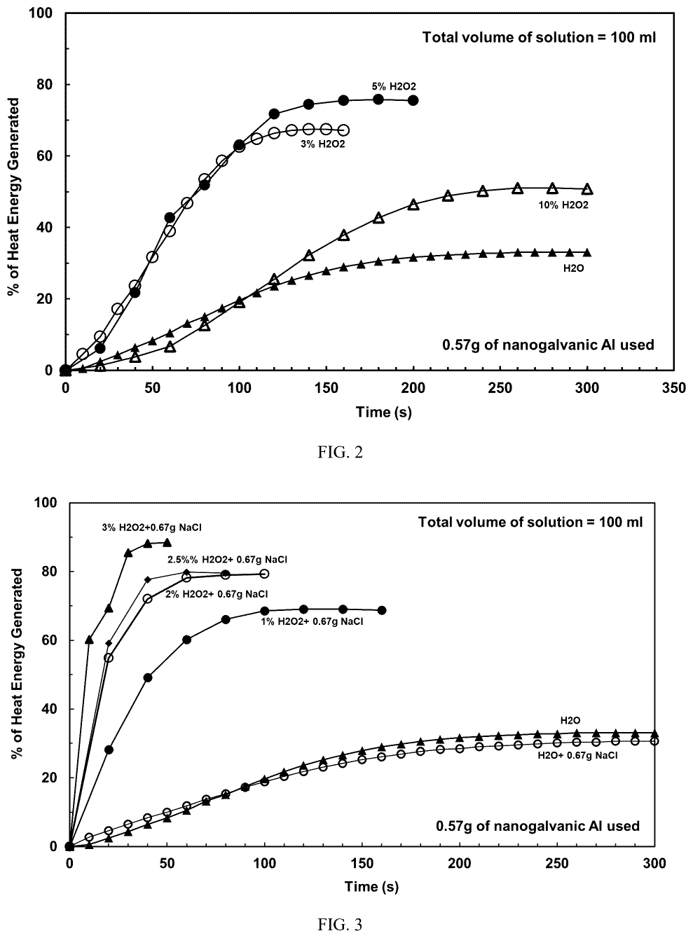

FIGS. 2-9 are various plots showing heat generation as a result of different reactions according to our experiments. We considered three examples for aluminum, magnesium, and AlGaIn for the hydrogen-producing substance 1. The plots confirm near theoretical heat production as a result of certain reactions according to embodiments of the present invention.

We first consider aluminum. When aluminum (Al) reacts with water to produce hydrogen gas, theoretically about 15.4 MJ of energy per kg. of Al is generated as heat of the exothermic reaction and about 15.9 MJ of energy per kg. of aluminum is generated in the form of hydrogen gas i.e. the energy obtained by burning hydrogen (H₂) gas. The total energy contained in aluminum is about 31.3 MJ per kg. of Al.

Of particular promise for Al-based materials, we have considered the utilization of nanogalvanic aluminum-based alloys for the hydrogen-producing substance 1 along with an oxidizer 2 (such as hydrogen peroxide) and/or salt 3 and balance water 4 for the purpose extracting the theoretical energy production in the form of heat only from nanogalvanic aluminum alloy as well to facilitate its rapid dissolution. Examples of the hydrogen producing metallic materials include nanogalvanic Al (Al-3 at % tin (Sn); 0.2 mole, i.e. 0.57 g was used) which was processed according to the aforementioned U.S. Pat. No. 11,198,923. In certain embodiments, the milled, powder composition comprises at least 0.1 atomic percent tin or bismuth or a mixture thereof. In certain other embodiments, the milled, powder composition comprises finely divided powder particles having diameters ranging from about 1 micron to about 10,000 microns. In other embodiments, the milled, powder composition comprises finely divided powder par-ticles having diameters ranging from about 1 micron to about 1,000 microns. In yet other embodiments, the milled, powder composition comprises finely divided powder par-ticles having diameters ranging from about 10 nanometers to about 1,000 nanometers. The powders for the nanogalvanic aluminum alloy as tested were particles having an average size (i.e., diameter/length) of about 50 microns.

The basis chemical equation showing heat production and hydrogen generation for the reaction of nanogalvanic aluminum alloy, as a hydrogen-producing substance, along with an aqueous solution of hydrogen peroxide as the oxidizer and NaCl as the salt is shown in equation (1) as follows:

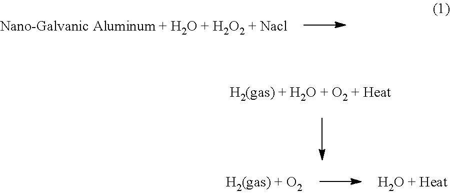

By reacting nanogalvanic Al (Al-3 at. % Sn) with water, hydrogen peroxide and ordinary table salt comprising predominantly sodium chloride (NaCl), we obtained as high as 92% 28.6 MJ per kg. of Al) of the total theoretical energy solely heat energy when we used 3% H₂O₂ in water along with 0.1 g of NaCl salt. For instance, the 31.3 MJ/kg of energy stored in nanogalvanic Al can be completely or near completely extracted by reaction with H₂O₂ and/or in the presence of other substances, like a salt. This can be accomplished by adding as little as just 3 vol % H₂O₂ added to water. The ability to extract this much heat in a single and simple process has important implications for energy production. Indeed, by contrast, in presently known Al water reactions only 15.4 MJ/kg of energy can be harvested as heat, with the remaining 15.9 MJ/kg of energy in the form of hydrogen gas (H₂).

It is worth noting that in our experiment, we did not adequately insulate the flask from the surroundings in our experiments. As a consequence, there was some dissipation of the generated heat during the reaction. Under proper insulation, the amount of generated heat energy would likely be even higher.

Alternative hydrogen producing materials employed in the experiments included magnesium (Mg; 0.2 mole, i.e. 0.47 g was used) and alloy of aluminum-gallium-indium (AlGaIn; 0.2 mole, i.e. 0.67 g was used). The oxidizers utilized comprised hydrogen peroxide (H₂O₂; 0.3-0.5 mole i.e. 1-15 wt. % was used) and potassium nitrate (KNO₃; 0.3-0.5 mole. i.e. 3.5-6.9 g), in conjunction with varying quantities of salt (NaCl).

Certain experiments involved the use of sodium chloride (NaCl)-based salt (0.25 milli mole-1.2 mole i.e. 0.001-6.7 g was used) and potassium chloride (KCl) salt (17 milli mole-0.11 mole i.e. 0.13-0.85 g was used). After adding the hydrogen producing material 1 to the aqueous solution AS, the temperature of the solution was measured every 10 or 20 sec using a thermocouple and the heat generated was calculated using the data of rise in solution temperature after addition of nanogalvanic powder and the heat capacity and mass of the solution. Commercially available NaCl-based salt (predominantly sodium chloride; Chef's Quality, R.D. Enterprises, College Point, NY 11356) was used. A 50% (by wt.) solution of hydrogen peroxide was procured from GFS Chemicals, 800 Kaderly Drive, Columbus, OH 43026 and was diluted as necessary using high-performance liquid chromatography (HPLC) water (VWR BD Chemicals, Cat. #BDH23595.400). The magnesium was purchased from Thermo Scientific (Cat. #010233.22). Potassium Chloride (Cat. #P9333-500G) and Potassium Nitrate (Cat. #P8394-500G were procured from Sigma-Aldrich. Magnesium powder was purchased from Thermo Scientific (Cat. #010233.22). AlGaIn alloy was produced by cryomilling 6.5 g of Al, 3.0 g Ga and 0.5 g of In for 4 h. The Mg powders as tested had a diameter/length ranging from about 1-45 microns. The AlGaIn powders as tested had an average diameter/length ranging from 50-100 microns.

Due to insufficient insulation of the flask from the surroundings, there was heat dissipation during the reaction, leading to less than 50% of the observed heat generation in our experiments when using just water. Nevertheless, the addition of oxidizers (hydrogen peroxide and potassium nitrate) and/or salt (sodium chloride and potassium chloride) consistently resulted in enhanced heat generation.

FIG. 2 shows the percentage of heat energy of what would be the total theoretical energy produced (i.e. that from the heat-of-reaction plus that if the hydrogen was combusted) versus time as a result of reacting nanogalvanic Al (Al-3 at. % Sn) with different concentrations of hydrogen peroxide (H₂O₂) in water.

FIG. 3 shows the percentage of heat energy of what would be the total theoretical energy produced (i.e. that from the heat-of-reaction plus that if the hydrogen was combusted) versus time as a result of reacting nanogalvanic aluminum powder (Al-3 at. % Sn) with different concentrations of H₂O₂ in water in the presence of a fixed dissolved concentration of table salt, NaCl.

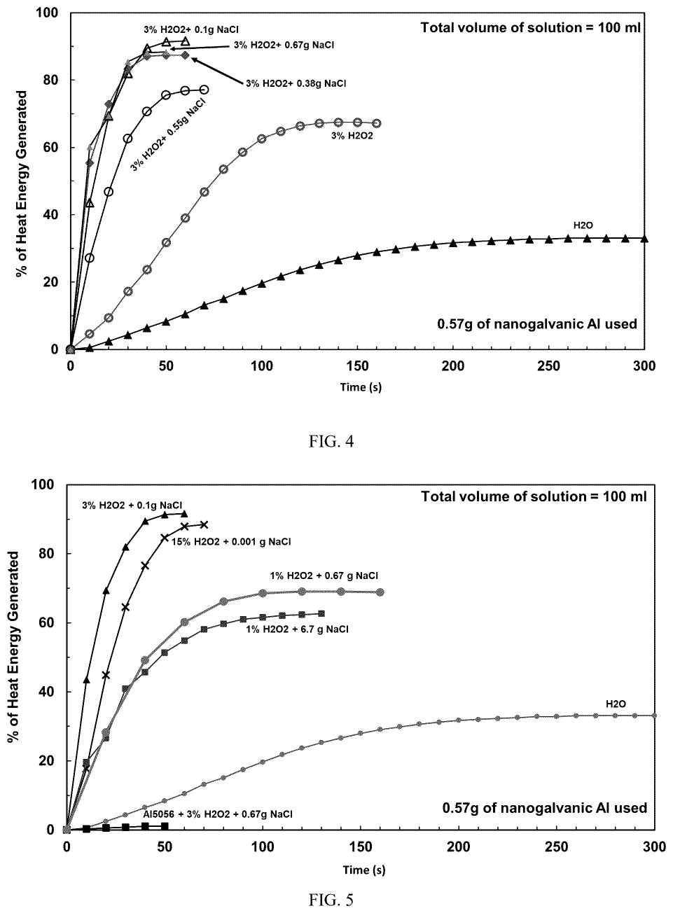

FIG. 4 shows the percentage of heat energy of what would be the total theoretical energy produced (i.e. that from the heat-of-reaction plus that if the hydrogen was combusted) versus time after reacting nanogalvanic aluminum (Al-3 at. % Sn), 3% H₂O₂ and various concentrations of salt.

FIG. 5 shows the percentage of heat energy of what would be the total theoretical energy produced (i.e. that from the heat-of-reaction plus that if the hydrogen was combusted) versus time after reacting nanogalvanic aluminum (Al-3 at. % Sn) with 15% H₂O₂ and minute amount of salt (˜0.001 g) and also with 1% H₂O₂ and relatively large amount of salt (6.7 g). For comparison, the data for the maximum heat generated using 3% H₂O₂ and 0.1 g of salt is shown; so also the data corresponding to the base aluminum comprising nanogalvanic aluminum which shows almost no heat generation.

We found that about 88% of the theoretical total energy could be generated using relatively concentrated (˜15% by wt.) H₂O₂ and very little salt which is close to 92% of the energy obtained using relatively dilute (3% by wt.) H₂O₂ along with relatively larger amount of the salt. The user can choose the option that is economically and or environmentally feasible for the applications pertaining to the utilization of heat generated.

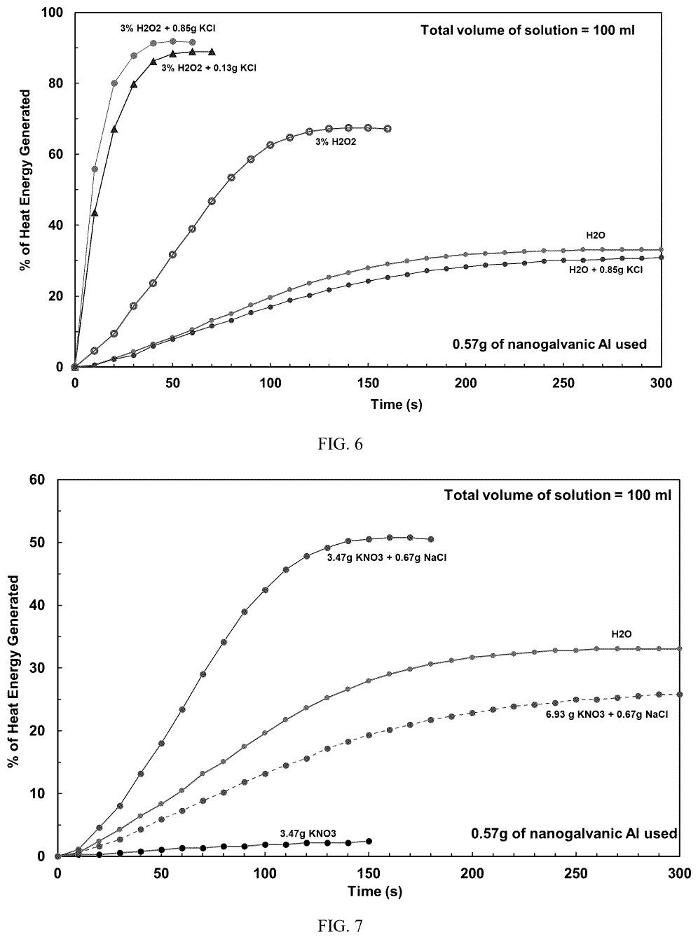

FIG. 6 shows the percentage of heat energy of what would be the total theoretical energy produced (i.e. that from the heat-of-reaction plus that if the hydrogen was combusted) versus time after the reaction of nanogalvanic aluminum (Al-3 at. % Sn) with water containing 3% hydrogen peroxide (H₂O₂) and varying concentration of KCl instead of NaCl based salt. It is important to highlight that the graph also includes the heat generated solely from KCl, excluding H₂O₂. Notably, there is slightly lower heat generation observed when using only salt as opposed to the nanogalvanic aluminum. The slower generation of hydrogen gas, observed when reacting aluminum alloys with seawater which contains predominantly sodium chloride, is attributed to the presence of sodium chloride, as reported by J. Lu, et al., “Controlled hydrogen generation using interaction of artificial seawater with aluminum plates activated by liquid Ga—In alloy,” RSC Adv. 2017, 7, 30839-30844, which is similar to KCl. This is indicative of lower heat generation as well.

FIG. 7 shows the percentage of heat energy of what would be the total theoretical energy produced (i.e. that from the heat-of-reaction plus that if the hydrogen was combusted) versus time after the reaction of nanogalvanic aluminum (Al-3 at. % Sn) with water containing different amounts of KNO₃, also an oxidizer like hydrogen peroxide and fixed amount of NaCl-based salt. It is clear from the plot that addition of 3.467 g of KNO₃ and 0.67 g of NaCl-based salt produced maximum heat.

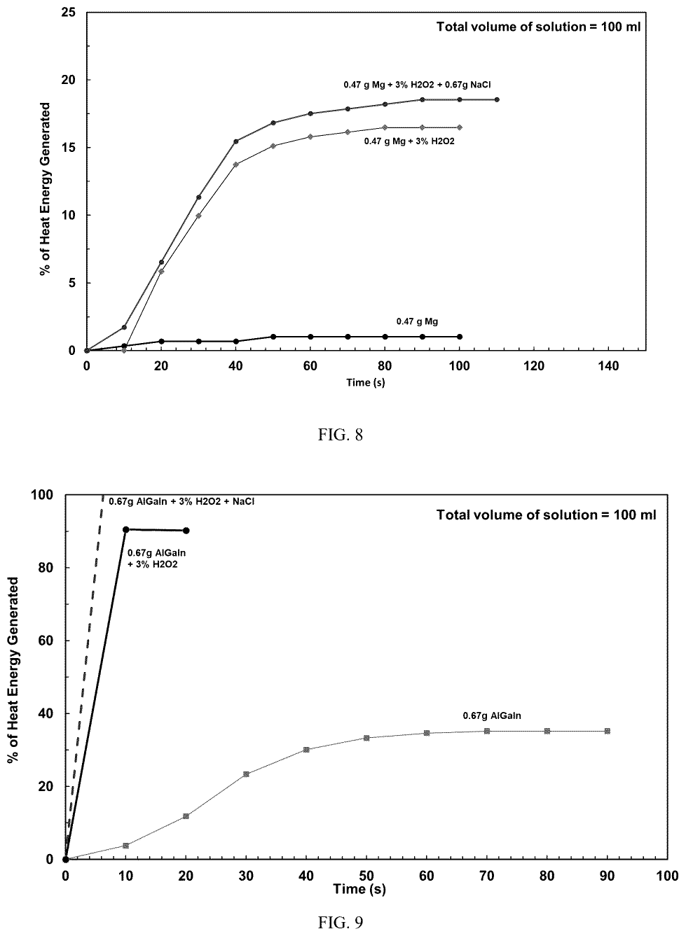

FIG. 8 shows the percentage of heat energy of what would be the total theoretical energy produced (i.e. that from the heat-of-reaction plus that if the hydrogen was combusted) versus time after reacting magnesium in water and in 3% H₂O₂ and also NaCl-based salt. The addition of hydrogen peroxide and salt increased the heat generation. It should be noted that in our experiment we did not insulate the flask appropriately from the surroundings and this resulted in some loss of the generated heat during the reaction.

Magnesium like aluminum reacts with water to produce heat, hydrogen gas and magnesium hydroxide. The basis chemical equation showing heat production and hydrogen generation for the reaction of magnesium, as a hydrogen-producing substance, along with an aqueous solution of hydrogen peroxide as the oxidizer and NaCl as the salt is shown in equation (2) as follows:

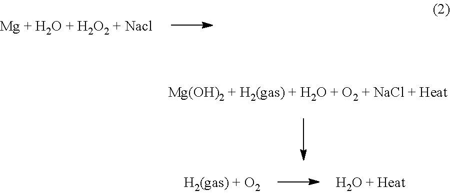

The theoretically heat yield is 14.6 MJ per kg Mg heat via the hydrolysis reaction. Of this, 11.7 MJ per kg Mg of energy is ordinarily generated in the form of hydrogen gas, i.e. the energy obtained by burning hydrogen (H₂) gas, without the oxidizer and the optional salt.

However, immediate oxidation (referred to in this case as passivation) occurs at room temperature when the particles come in contact with air or water to form a continuous passivation layer on the free surface. This passivation layer inhibits further reaction with water preventing further hydrolysis. Thus, there is provided an improvement in heat generation by the hydrolysis reaction.

FIG. 9 shows when AlGaIn alloys come into contact with water, they generate hydrogen gas. The basis chemical equation showing heat production and hydrogen generation for the reaction of AlGaIn, as a hydrogen-producing substance, along with an aqueous solution of hydrogen peroxide as the oxidizer and NaCl as the salt in equation (3) as follows:

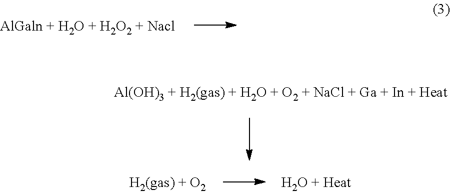

For AlGaIn, heat is predominantly generated by the reaction of Al with water. Thus, we assume a similar heat generation value up to about 31.3 MJ per kg of Al. The embrittlement of aluminum occurs due to the intergranular diffusion of gallium (Ga) and indium (In), preventing the formation of a passivating layer on aluminum and allowing continuous hydrogen production. See J. T. Ziebarth, et al., “Liquid Phase-enabled reaction of Al—Ga and Al—Ga—In—Sn alloys with water,” Int. J. Hydrogen Energy 2011, 36, 5271-5279. In this plot, we observe that nearly 40% of the total energy manifests as heat during the reaction of AlGaIn with water. This percentage significantly rises to about 95% when hydrogen peroxide (H₂O₂) is introduced. Furthermore, the addition of both salt and H₂O₂ results in an overpressured reaction flask, signifying the instantaneous generation of large volume of hydrogen gas. This is accompanied by a rapid and substantial increase in temperature, with the reaction liquid (i.e., the solution of salt and hydrogen peroxide) experiencing a 60° C. rise practically instantaneously. Thus, there is provided an improvement in heat generation by the hydrolysis reaction.

All patent documents and other publications mentioned in the specification are indicative of the levels of those skilled in the art to which the invention pertains. These documents and publications are incorporated herein by reference in their entirety to the same extent as if each individual document or publication was specifically and individually incorporated herein by reference.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

1. A method for increasing the heat yield for a substance which reacts with water to produce hydrogen gas and heat, said method comprising:
providing a substance which reacts with water to produce hydrogen gas and heat;
providing an aqueous solution comprising an oxidizer and an optional salt; and
reacting the substance and the aqueous solution to generate hydrogen and heat.

2. The method of claim 1, wherein the oxidizer is selected from the group consisting of:
hydrogen peroxide (H₂O₂), potassium nitrate (KNO₃), sodium nitrate (NaNO₃), potassium permanganate (KMNO₄), chromium trioxide (CrO₃) and potassium dichromate (K₂Cr₂O₇).

3. The method of claim 2, wherein the oxidizer comprises hydrogen peroxide.

4. The method of claim 1, wherein the oxidizer comprises 1-50% (by wt.) of the aqueous solution.

5. The method of claim 1, wherein the salt is present in the aqueous solution.

6. The method of claim 5, wherein the salt is selected from the group consisting of: sodium chloride (NaCl), potassium chloride (KCl), rubidium chloride (RbCl) and cesium chloride (CsCl).

7. The method of claim 5, wherein the salt comprises 0.5 milli mole to 10 moles of the aqueous solution.

8. The method of claim 1, wherein the substance which reacts with water to produce hydrogen gas and heat comprises: aluminum (Al), Al-alloys, magnesium (Mg), Mg-alloys, zinc (Zn), Zn-alloys, silicon (Si) or Si-based compositions.

9. The method of claim 8, wherein the aluminum alloy is selected from the group consisting of: nanogalvanic aluminum alloy, aluminum alloys of 1000, 2000, 3000, 5000, 6000, and 7000 series and Al alloys containing Ga and/or In.

10. The method of claim 9, wherein the nanogalvanic aluminum alloy is Al-3 at. % Sn or Al-3 at % Bi.

11. The method of claim 8, wherein the magnesium alloy is selected from the group consisting of: AMxx, ASxx, AZxx, ZKxx, EZxx, ZExx, QExx, EQxx, and WExx.

12. The method of claim 8, wherein the zinc alloy comprises Zn—Mg alloy.

13. The method of claim 8, wherein the Si composition comprises Si—Fe composition.

14. The method of claim 1, wherein, for Al-containing substances, there is an increase in heat generated of at least 10.5 MJ per kg of Al, and for Mg-containing substances, there is an increase in heat generated of least 0.6 MJ per kg for Mg, compared to the reaction of the substance and water without the oxidizer and the optional salt.

15. The method of claim 1, further comprising milling the substance which reacts with water to produce hydrogen gas and heat to reduce particle size.

16. The method of claim 1, wherein the substance which reacts with water to produce hydrogen gas and heat has an average particle size of 10 nm to 10,000 microns.

17. A material system for producing hydrogen gas and heat, said material system comprising:
a substance which reacts with water to produce hydrogen gas and heat; and
an aqueous solution comprising an oxidizer and an optional salt,
wherein the aqueous solution increases the heat yield for the substance's reaction with water.

18. The material system of claim 17, wherein the substance is milled.

19. An aqueous solution for increasing the heat yield for a substance which reacts with water to produce hydrogen gas and heat, said solution comprising:
an oxidizer, comprising 1-50% (by wt.) of the aqueous solution, selected from the group consisting of: hydrogen peroxide (H₂O₂), potassium nitrate (KNO₃), sodium nitrate (NaNO₃), potassium permanganate (KMNO₄), chromium trioxide (CrO₃) and potassium dichromate (K₂Cr₂O₇);
a salt, comprising 0.5 milli mole to 10 moles of the aqueous solution, selected from the group consisting of: sodium chloride (NaCl), potassium chloride (KCl), rubidium chloride (RbCl) and cesium chloride (CsCl); and
water.
